(19) United States
(12) Patent Application Publication
(10) Pub. No.: US 2019/0291624 A1
(43) Pub. Date: Sep. 26, 2019

(54) HYDRAULIC TRUCK BED LIFTING APPARATUS AND METHOD

(71) Applicant: Greg Ferguson, Phoenix, AZ (US)

(72) Inventor: Greg Ferguson, Phoenix, AZ (US)

(21) Appl. No.: 15/934,970

(22) Filed: Mar. 24, 2018

(51) Int. Cl. B60P 1/48

(52) U.S. Cl. CPC B60P 1/48

(57) ABSTRACT

The invention is an apparatus and method for lifting objects onto the bed of a pick-up truck. The device includes (1) a rack assembly, (2) a swing arm assembly, and (3) at least one hydraulic arm. The invention can be optimized and adapted to fit on a standard pick up truck or a flat bed truck.

### CROSS-REFERENCE TO RELATED APPLICATION(S)

Not applicable

### BACKGROUND OF THE INVENTION

### 1. Field of Invention

This invention relates to pickup trucks. Specifically, this invention relates to an apparatus and method for modifying a pickup truck to include a lifting apparatus capable of moving one or more heavy work pieces into and out of the bed of the truck.

### 2. Description of Related Art

A typical pickup truck includes a separate cabin (referred to herein as a cab) from which the driver and passenger(s) may be seated. As used herein the term cab includes various different styles of cabs such as a standard cab, an extended cab, crew cab, and cab-forward design. In addition a typical pickup truck includes a rear load area or compartment referred to as a bed.

A typical bed of a pickup truck corresponds to a well-type bed that includes short rigid side walls. The back of such beds typically include an opening that may optionally include a rear gate (“tailgate”) for closing the opening. Such beds are positioned adjacent the rear wheels of the truck. Thus the side walls of the bed typically include portions of the rear wheel wells which extend into the bed.

The minimum distance between the outer surfaces of the wheel wells on either side of the bed is typically smaller than the minimum distance between portions of the side walls on opposed sides of the bed that are adjacent to the wheel wells. Also the adjacent portions of the side walls of the bed typically extend higher and over the portions of the side wall that correspond to the wheel wells. As a result, the width of the bed, for accommodating objects adjacent the floor of the bed, is typically limited by the minimum width between the wheel wells. As an example, a truck with a “full-size long bed” may have a size that can carry a standard-sized 4×8 foot sheet of plywood or drywall with a closed tailgate.

A typical pickup truck includes a frame under the bed of the truck that provides sufficient structural support for enabling the bed of the truck to store heavy objects. The load capacity of a truck refers to the maximum amount of weight the truck is designed to safely handle. For example, the springs, chassis, bed and other structural features of a “one ton” truck may be capable of enabling the truck to carry several thousands of pounds in the bed of the truck.

Although pickup trucks are designed to carry heavy objects in the bed of the truck, such objects may have a weight which is too heavy for an individual to safely lift into the bed of the truck. As a result, there exists a need for a device operated by a single person which can be used to move heavy objects into and out of a bed of a pickup truck.

The prior art has put forth several apparatuses and mechanisms to assist lifting heaving objects onto the bed of a pickup truck. Among these are:

U.S. Pat. No. 4,019,781 to Ray describes an attachment for converting a fixed bed truck with a passenger cab and hauling bed supported on a frame to a tilting bed truck.

U.S. Pat. No. 4,710,090 to DeLuca et al. describes a hydraulic hoist particularly for mounting on pick-up truck beds or the like.

U.S. Pat. No. 6,196,634 to Jurinek describes a dumping bed liner for pickup truck.

U.S. Pat. Appl. No. 2009/0115238 to Lane describes a lifting device mounted to a bed of a pickup truck. This device includes a lifting frame, which includes a first and second booms with a beam therebetween.

U.S. Pat. No. 7,300,239 to Benedikt describes a hoist for loading and unloading objects on a truck bed.

U.S. Pat. No. 8,534,981 to Bortz describes a truck bed bale loader auxiliary assembly.

The prior art also provides for various utility attachments to pickup trucks. For example, a vehicle fitted with a set of dual-front and rear crossbar racks could be made to carry ladders, wood, pipes, and the like.

The foregoing prior art does not describe the present invention.

### SUMMARY OF THE INVENTION

A lifting apparatus mounted on a pick-up truck comprising:

(a) a rack assembly

(b) a swing arm assembly

(c) at least one hydraulic arm

A method of hoisting an object onto the bed of a pick-up truck, using a lifting device comprising:

(a) a rack assembly

(b) a swing arm assembly

(c) at least one hydraulic arm

The foregoing, and other features and advantages of the invention, will be apparent from the following, more particular description of the preferred embodiments of the invention and the claims.

### BRIEF DESCRIPTION OF THE DRAWINGS

FIG. 1A is a perspective view representative of an embodiment of a lifting device mounted in the bed of a pickup truck with side rails.

FIG. 1B is a perspective view representative of an embodiment of a lifting device mounted in the bed of a flatbed pickup truck. In this figure, Component (I) designates the Rack Assembly; Component (II) designates the Swing Arm Assembly, and Component (III) designates the components of the hydraulic motors and arms.

FIG. 1C is a perspective view showing a lifting frame of the lifting device mounted in a pickup truck in an extended position and also displaying the full arc of movement of the lifting frame relative to the bed of the pickup truck.

FIG. 1D is a perspective view representative of a lifting device without the pickup truck which outlines the main sections of the invention, according to an embodiment. In this figure, Component (I) designates the Rack Assembly; Component (II) designates the Swing Arm Assembly, and Component (III) designates the components of the hydraulic motors arms.

FIG. 1E is an optional embodiment of the invention where the invention is secured directly to the truck bed and lacks connection with the pickup's side rails, which are absent.

FIG. 2A is a component view of a Rack Assembly, according to an embodiment of the invention.

FIG. 2B is a perspective view of a Rack Assembly, according to an embodiment of the invention. This view shows the extendable hoist bar vertically extended from the rest of the Rack Assembly.

FIG. 3 is a component view of the swing arm assembly.

FIG. 4 is a component view of a Left Stationary Angle, according to an embodiment of the invention.

FIG. 5 is a component view of a Right Stationary Angle, according to an embodiment of the invention.

FIG. 6 is a view of the Left Stationary Arm secured to the Left Swing Arm at the pivot point articulation. The perspective of this view is from the bed of the truck looking outward.

FIG. 7 is a view of the Left Stationary Arm secured to the Left Swing Arm at the pivot point articulation. The perspective of this view as from outside of the truck looking inward.

FIG. 8 is a view of the Left Stationary Arm secured to the left rail of the pickup truck.

FIG. 9 is a view of a sensor.

FIG. 10 is a view of the connecting pieces to secure the invention directly to the truck frame.

FIG. 11 is a view of the locking safety mechanism.

FIG. 12 is a rear view of the invention as if installed on a flat bed truck.

FIG. 13 is a rear view of the invention as if installed on a standard pick up truck.

FIG. 14 is a view of the metal hydraulic lines that support the invention.

FIG. 15 is a close-up view of the metal hydraulic lines that support the invention.

FIG. 16 is a close-up view of the L-joints within the metal hydraulic lines that support the invention.

### DETAILED DESCRIPTION OF PREFERRED EMBODIMENTS

The present invention, briefly described, provides a hydraulic truck bed lifting apparatus and method.

The present invention has many advantages over the prior art. This includes, but is not limited to: 1) improved convenience in the attachment means; 2) improved lifting capability with hydraulic operation; 3) improved efficiency through compact frame structure; 4) improved productivity; and, 5) reduced need for additional equipment or health risks in loading heavy objects manually.

The above brief description sets forth rather broadly the more important features of the present invention in order that the detailed description thereof that follows may be better understood, and in order that the present contributions to the art may be better appreciated.

In this respect, before explaining a number of preferred embodiments of the invention in detail, it is understood that the invention is not limited in its application to the details of the construction and to the arrangements of the components set forth in the following description. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention.

It is an object of at least one embodiment of at least one of the inventions described herein to provide a method and a device which can be used to move heavy objects into and out of a bed of a pickup truck.

It is a further object of at least one embodiment of at least one of the inventions described herein to provide a method and a device which can be used by a single person (the “operator”) to move heavy objects into and out of a bed of a pickup truck.

The foregoing objects may be accomplished by a lifting device that is operative to mount to a bed of a truck. The truck may correspond to a pickup truck and includes a bed located between a cab and a back of the truck.

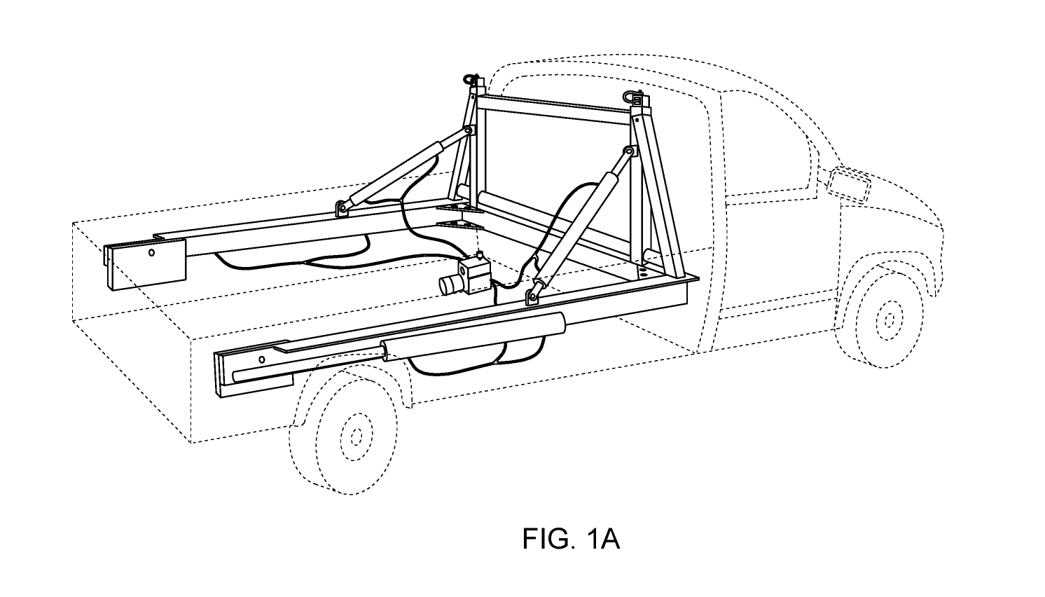

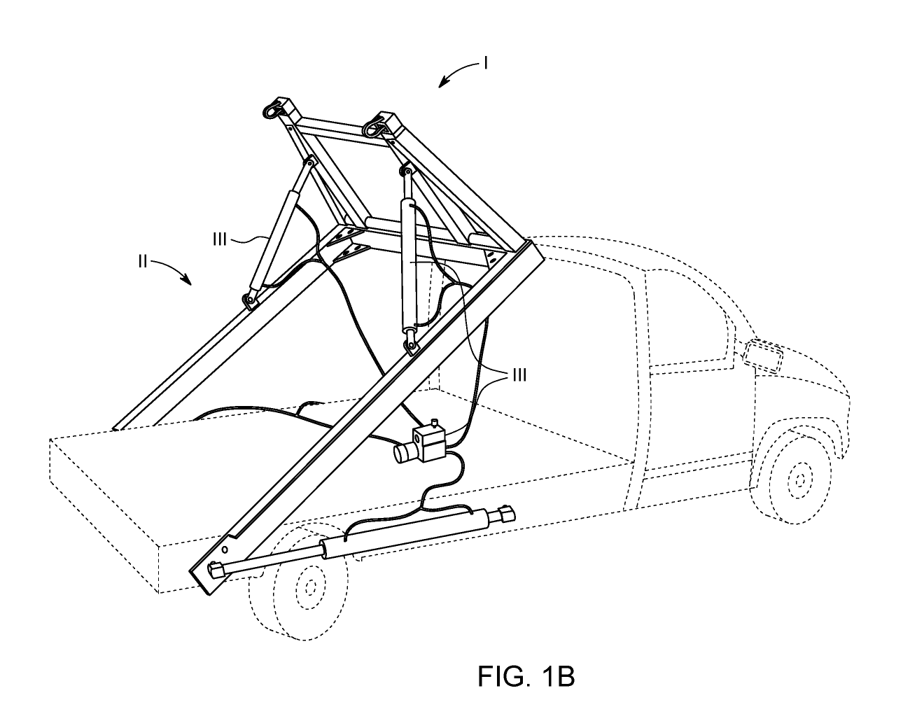

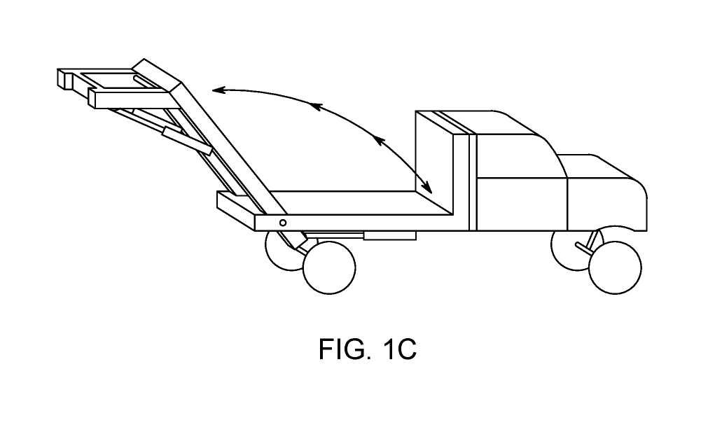

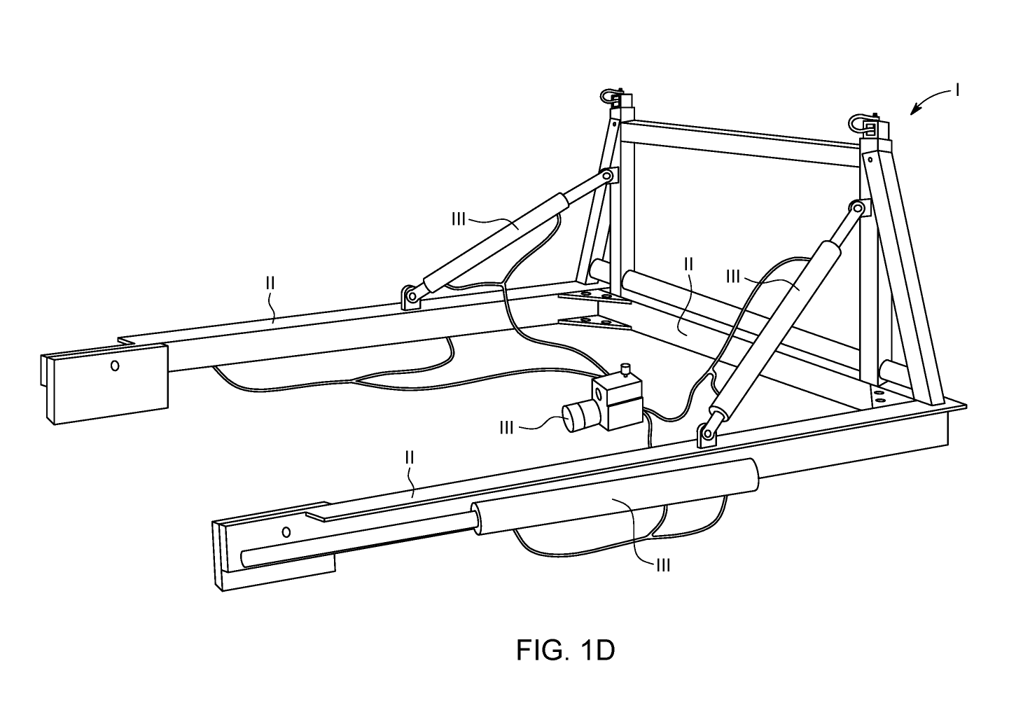

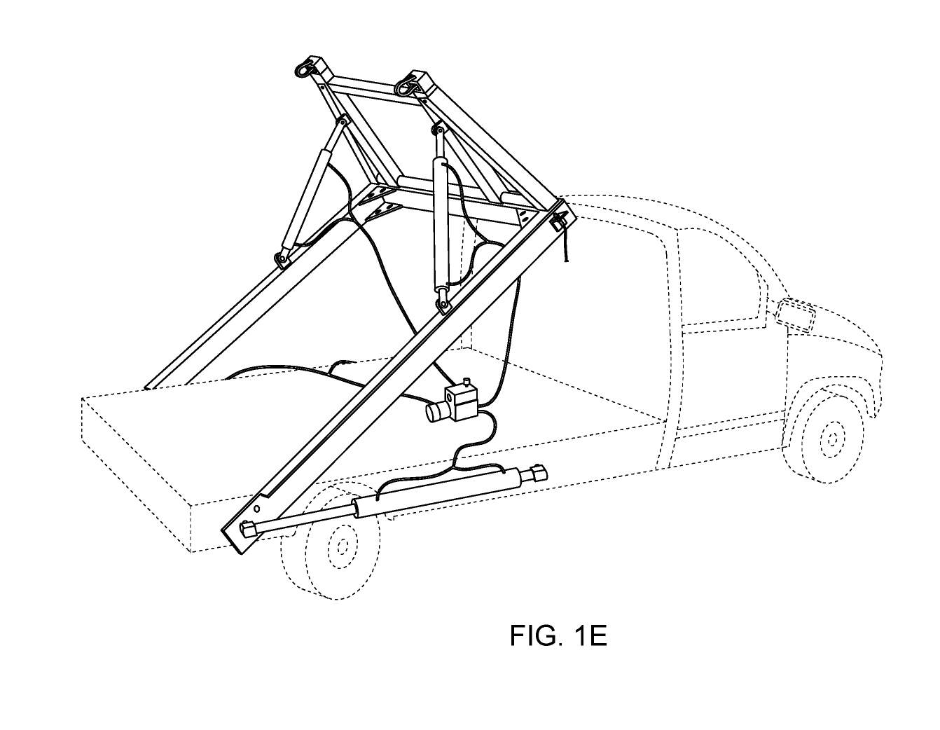

Reference is made to FIG. 1A, which is a perspective view representative of an embodiment of a lifting device mounted in the bed of a pickup truck with side rails.

The lifting device includes a lifting frame operative to mount in pivoting connection with the bed of the truck. The lifting frame includes a Rack Assembly, a Swing Arm Assembly, a Left Stationary Arm, a Right Stationary Arm, and four hydraulic cylinders.

Reference is made to FIG. 1B, which is a perspective view representative of an embodiment of a lifting device mounted in the bed of a flatbed pickup truck. In this figure, Component (I) designates the Rack Assembly; Component (II) designates the Swing Arm Assembly, and Component (III) designates the components of the hydraulic motors and arms.

As a general matter, the operator of the lifting device “deploys” the lifting device through the use of four hydraulic cylinders. Once “deployed”, the lifting device extends horizontally over the bed of the truck. There, one of skill in the art would connect the lifting device with a load. When the load is secured, the operator “retracts” the lifting device, at which time the load is brought into the bed of the truck and the truck's tailgate is closed. At this time, the load can be safely transported by the truck to the location desired by the operator.

Reference is made to FIG. 1C, which is a perspective view showing a lifting frame of the lifting device mounted in a pickup truck in an extended position and also displaying the full arc of movement of the lifting frame relative to the bed of the pickup truck.

The operator can remove the load from the truck by “deploying” the lifting device through the use of the hydraulic system, which extends the load outside the truck. Once the load is lowered and removed from the lifting device, the lifting device can be safely “retracted”.

One of skill in the art would be able to coordinate use of the hydraulic cylinders for proper deployment and retraction of the lifting device without undue experimentation.

Unless specified as individual components, the lifting device can be made of any strong, but light-weight metal that is available to one of skill in the art. However, in a preferred embodiment, the components of the lifting device is made of steel.

Reference is made to FIG. 1D is a perspective view representative of a lifting device without the pickup truck which outlines the main sections of the invention, according to an embodiment. In this figure, Component (I) designates the Rack Assembly; Component (II) designates the Swing Arm Assembly, and Component (III) designates the components of the hydraulic motors arms.

Reference is made to FIG. 1E, which is an optional embodiment of the invention where the invention is secured directly to the truck bed. This is the preferred embodiment to secure the invention to flat bad trucks.

If the invention is secured to trucks with side rails, then use of the side rail attachments is preferred.

It is also envisioned that the invention can be adapted to trailers and most vehicles.

### (I) Rack Assembly

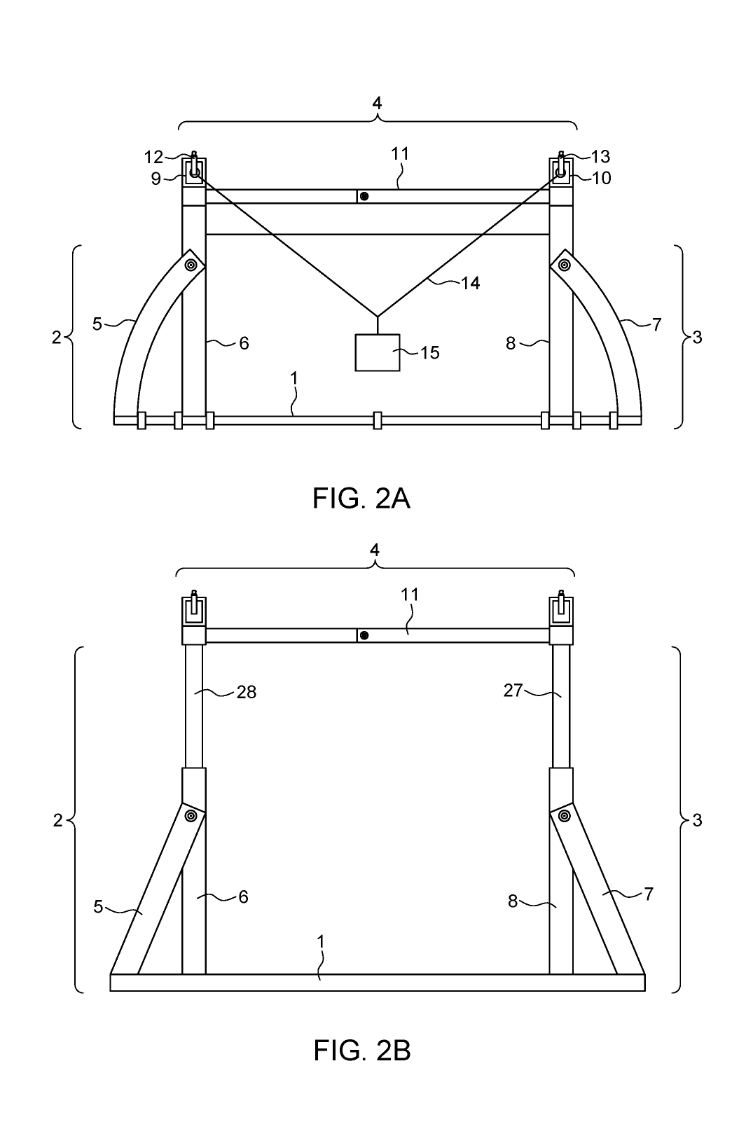

Reference is also made to FIG. 2A, which is a component view of a Rack Assembly, according to an embodiment of the invention.

As a general matter, the (1) Rack Assembly contains (1) a support base, (2) a left support structure, (3) a right support structure, and (4) an extendable hoist bar.

In a preferred embodiment, the (1) support base is a ⅝″ hardened steel shaft that employs a ⅝″ pillow block for the articulations. Such pieces are commonly used by people trained art and are commercially available, for sample the UCP202-10 Pillow Block Bearing ⅝″ Bore 2 Bolt sold by Jeremywell.

This design allows the Rack Assembly to roll forward during retraction of the lifting device or backward during deployment of the lifting device. This design is preferred over the use of weak hinges.

The (1) support base connects with a (2) left support structure and a (3) right support structure.

In a preferred embodiment, both the (2) left support structure and the (3) right support structure are triangular in shape. In this preferred embodiment, the (2) left support structure is composed of a (5) left diagonal support structure and (6) a left vertical support structure. Likewise, the (3) right support structure is composed of a (7) right diagonal support structure and a (8) right vertical support structure.

The (6) left vertical support structure and the (8) right vertical support structure are both hollow at their vertical portions to allow for the insertion of the (4) extendable hoist bar.

The (4) extendable hoist bar is composed of a (9) left vertical portion, a (10) right vertical portion, a (11) crossbeam, a (12) left shackle, a (13) right shackle, and a (14) load strap. It is designed that the (9) left vertical portion of the extendable bar inserts into the (6) left vertical support structure while the (10) right vertical portion of the extendable bar inserts into the (8) right vertical support structure.

In a preferred embodiment and while “retracted”, the (9) left vertical portion of the extendable bar inserts into the (6) left vertical support structure to 18 inches while the (10) right vertical portion of the extendable bar inserts into the (8) right vertical support structure to 18 inches.

Further, the (12) left shackle and the (13) right shackle are attachment points for the (14) load strap. Both the (12) left shackle and the (13) right shackle are composed of materials available to one of skill in the art designed to support the anticipated load. Further, the (14) load strap is composed of a structural material that can support the weight of the load. One of skill in the art can select such materials from those commonly known in the field for the (14) load strap, but in a preferred embodiment, it is made of an industrial-grade nylon belt. Item (15) represents the load in this diagram.

The extension of the extendable hoist bar is demonstrated in FIG. 2B, which is a perspective view of a Rack Assembly, according to an embodiment of the invention. This view shows the extendable hoist bar vertically extended from the rest of the Rack Assembly. This reveals the (28) left extensor column and (29) right extensor column. Otherwise, the numbering is the same as in FIG. 1A.

### (II) Swing Arm Assembly

Reference is made to FIG. 1D, which shows the location of the (II) Swing Arm Assembly relative to the other components of the invention and the truck.

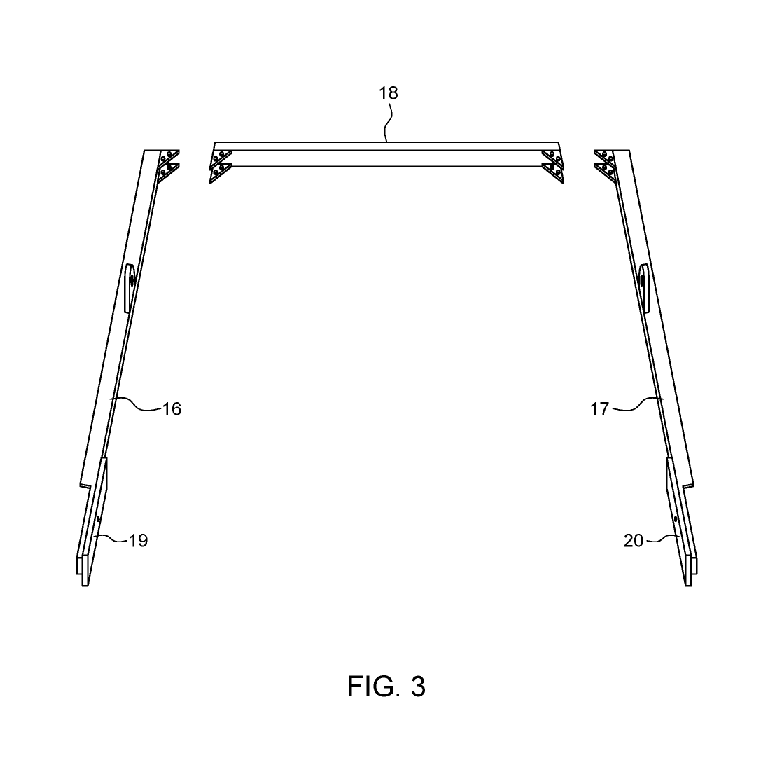

Reference is also made to FIG. 3, which shows the individual components of the Swing Arm Assembly.

The (II) Swing Arm Assembly is comprised of a (16) left swing arm, a (17) right swing arm, and (18) a swing arm assembly crossbeam.

In a preferred embodiment, both the (16) left swing arm and the (17) right swing arm are 73½″ long×3½″×5″ angle×¼″ thick. Likewise, the (16) left swing arm, the (17) right swing arm, and (18) the swing arm assembly crossbeam form 90 degree angles to one another and are assembled in the manner displayed in FIG. 1D.

One of skill in the art would be able to secure the Swing Arm Assembly with the Rack Assembly without undue experimentation. In a preferred embodiment, the (18) the swing assembly crossbeam is welded to the (I) Rack Assembly, which is mounted on swing arm angle via a bearing cap.

A pair of triangle gussets are used to bolt the (II) Swing Arm Assembly with the (I) Rack Assembly. In a preferred embodiment, each triangle gusset is 5″×5″×¼″ thick.

### (21) Left Stationary Arm and (22) Right Stationary Arm

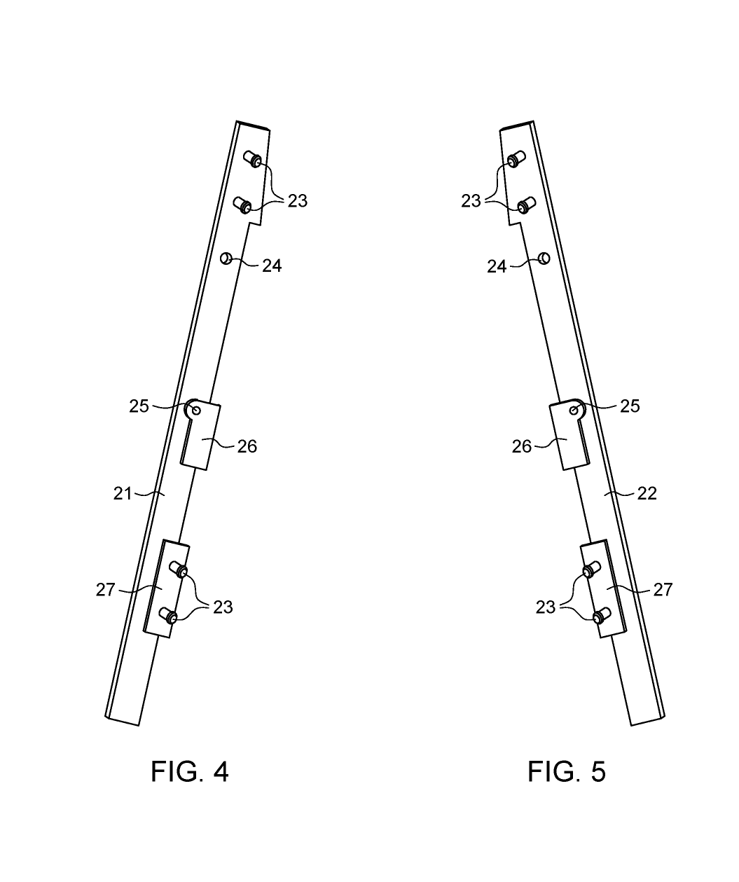

Reference is made to FIGS. 4 and 5, which display the (21) Left Stationary Arm and (22) Right Stationary Arm, respectively.

As a general matter, both the (21) Left Stationary Arm and the (22) Right Stationary Arm have identical components, except are mirror images of one another.

The (21) Left Stationary Arm secures the invention to the left rail bed of the truck while the (22) Right Stationary Arm secures the invention to the right rail bed of the truck.

In a preferred embodiment, both the (21) Left Stationary Arm and the (22) Right Stationary Arm are 76¼″×3″ (top flange) and 4″ (side flange) and is ¼″ thick.

Reference is also made to FIG. 3. Both the (21) Left Stationary Arm and the (22) Right Stationary Arm are secured to the (II) Swing Arm Assembly through the use of a (19) left pivot plate and a (20) right pivot plate, respectively. In a preferred embodiment, both the (19) left pivot plate and the (20) right pivot plate are 8″×24″×½″ plates which are welded to the (II) Swing Arm Assembly for pivoting action.

Reference is made to FIG. 1C, which shows the full rotation of the invention. In particular, it is envisioned that the (II) Swing Arm Assembly will rotate a full 130′ relative to the pivot points. In a preferred embodiment, it is envisioned that the invention can extend around 4′ beyond the tailgate in the retracted position and 6.5′ with the Rack Assembly fully extended.

One of skill in the art would know how to secure these items together. In a preferred embodiment, one uses a HF A325TC pivot bolt through a pivot bolt hole of each stationary arm (24), which measures ¾″ wide and 3½″ long with a tensile strength of at least 120,000 PSI. This is used with a ¾″ self-lubricating bronze bushing for pivot bolt, which is reinforced with a 1″ washer. This allows for a 130′ rotation for the (II) Swing Arm Assembly.

The pivot hole of each stationary arms are part of the pivot joint bracket (26), a metal plate attached to each stationary arm commonly used attached by one of skill in the art.

One of skill in the art can secure both the (21) Left Stationary Arm and the (22) Right Stationary Arm without undue experimentation. But in a preferred embodiment, they are both secured directly to the truck bed using 3″ by 4″ angle bolts or 3″ by 5″ angle mounts locations indicated on FIGS. 4 and 5 as item (23). Each stationary arm also incorporates a (27) mounting bracket, which are 1¾″ by 1¾″ by ¼″ thick. Alternatively, each mounting bracket uses 2 bolts, which are grade 8 and 2½″ in length. Each has ½″ threaded holes for the mounting bolts and welded gusset at each end for strength.

One of skill in the art can alter the pivot point attachments for both the (21) Left Stationary Arm and the (22) Right Stationary Arm to increase or decrease the reach of the hydraulic cylinders to hoist an object beyond the tailgate.

In a preferred embodiment, holes are provided for the hydraulic hose. These are indicated as item (25) on FIGS. 4 and 5.

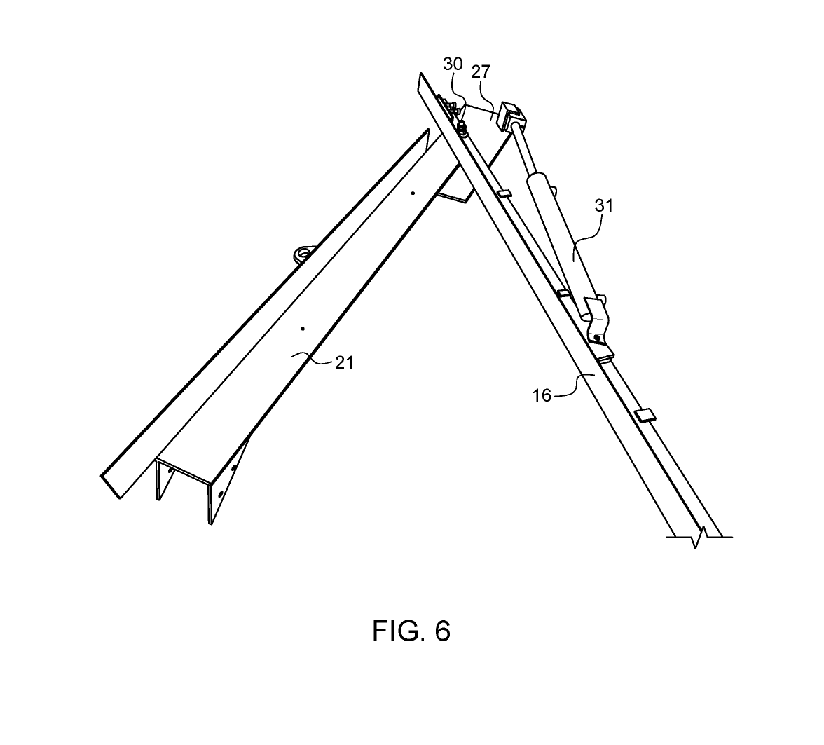

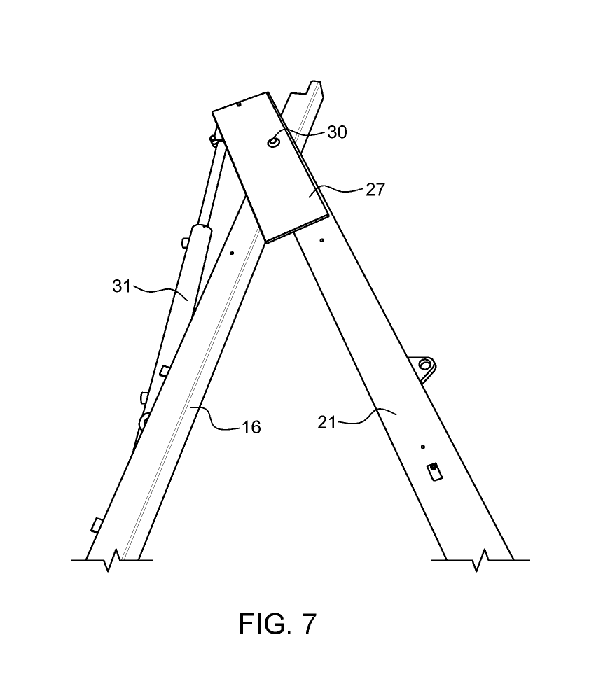

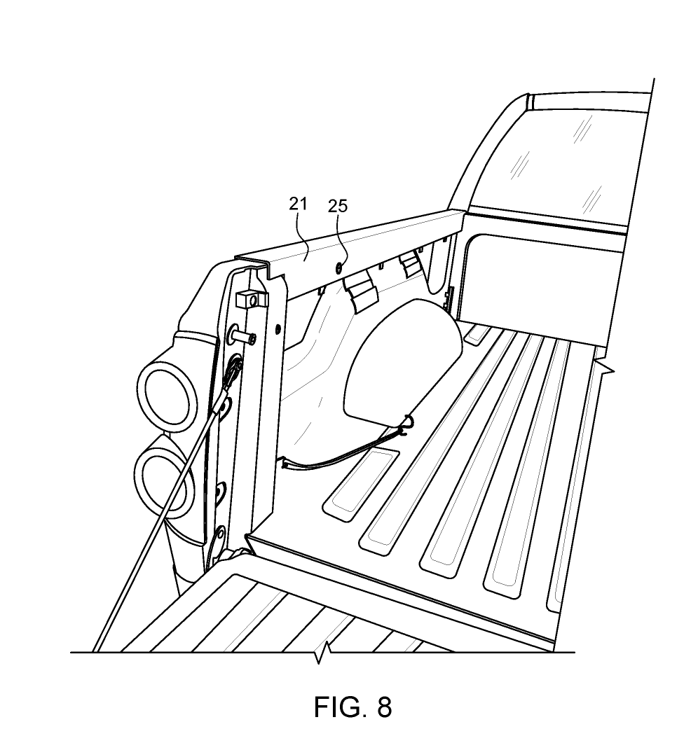

Reference is made to FIGS. 6 and 7. FIG. 6 is a view of (21) the Left Stationary Arm secured to (16) the left swing arm via a (30) bolt in the pivot bolt hole. The perspective of this view as from the bed of the truck looking outward. FIG. 7 is a view of the same but as if from the outside of the truck looking inward. One of skill in the art would recognize that the Right Stationary Arm and the Right Swing Arm would have similar articulations, but mirror image to FIGS. 6-7. Also displayed is (31) a hydraulic cylindrical arm with connects the (16) left swing arm with (27) mounting bracket.

Reference is made to FIG. 8, which is a view of (21) the Left Stationary Arm secured to the left rail of the pickup truck without the rest of the invention. Displayed from this perspective is (24) the pivot bolt hole of the Left Stationary Arm. One of skill in the art would recognize that (22) the Right Stationary Arm would secure to the right rail of the pickup truck in a similar manner, but mirror image to FIG. 8.

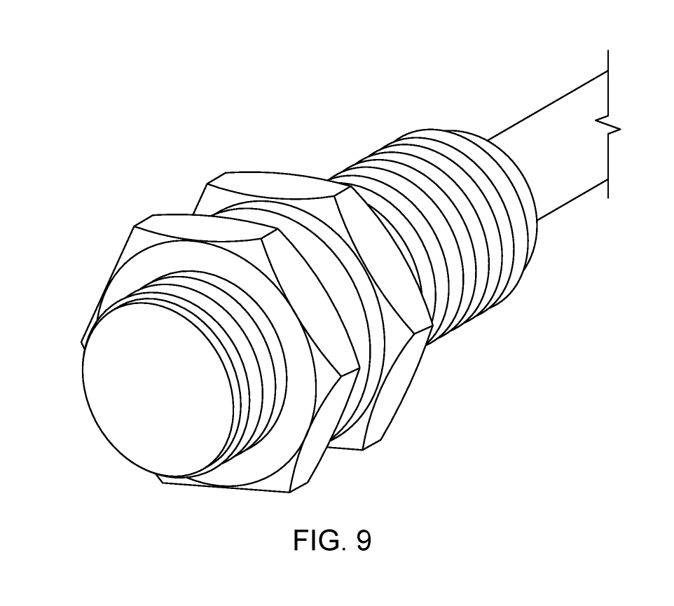

Reference is made to FIG. 9, which is a view of a sensor which can be incorporated into the device. In a preferred embodiment, the invention incorporates safety switches commonly known in the art. Such switches include the AUTOTONICS 1500 Hz Inductive Cylindrical Proximity Sensor with a maximum detecting distance of 1.5 mm. Another device is the Dayton Wobble Stick, Coil Spring General Purpose Limit Switch.

In a preferred embodiment, the proximity switches are employed in two places. One location is along the stationary arms and near the pivot point to detect over-rotation of the Swing Arm Assembly at the pivot point. The second location is at the juncture between the Swing Arm Assembly and the Rack Assembly to detect over-rotation of the Rack Assembly.

In a preferred embodiment, the limit switch is located on the Rack Assembly and positioned to detect contact with the truck cab.

In a preferred embodiment, once the limit or proximity switches detect over-rotation of the invention, the device would shut down.

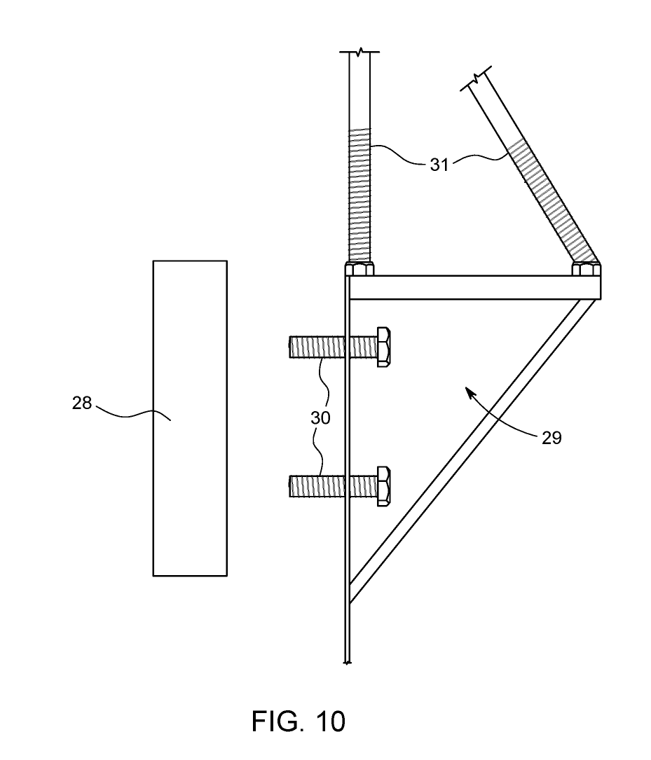

Reference is made to FIG. 10, which is a view of the connecting pieces to secure the invention directly to the truck frame. The stationary arms on the “pick-up” version have “all-thread” which attaches to the truck frame. In this view, item (28) depicts the truck frame; (29) represents the universal mount bracket for all thread, which can be adapted to all truck frames; (30) depicts a bolt in the pivot bolt between the mount bracket and the frame; and (31) depicts “all-thread.”

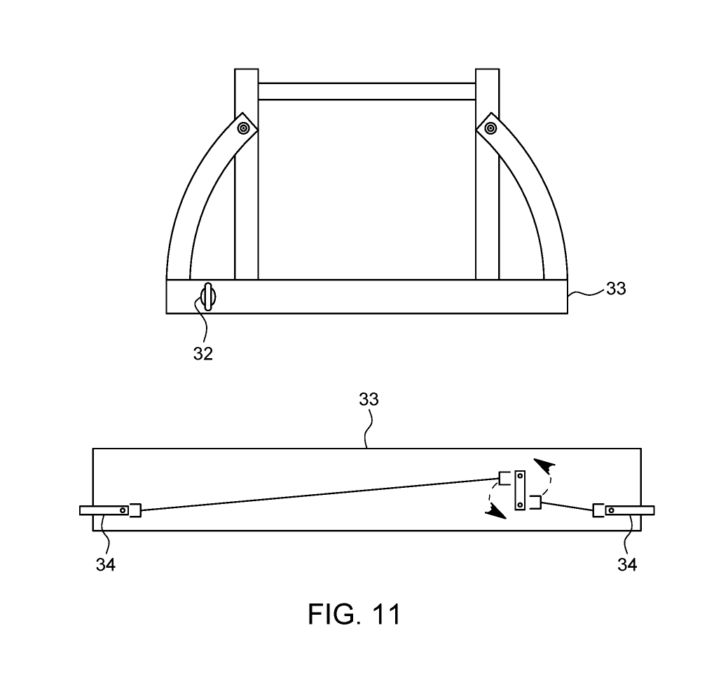

Reference is made to FIG. 11, which is a view of the locking safety mechanism. In this view, item (32) is a lock handle; (33) is a 5×3½×¼″ angle that the rack sits on; and (34) is a sliding dead bolt.

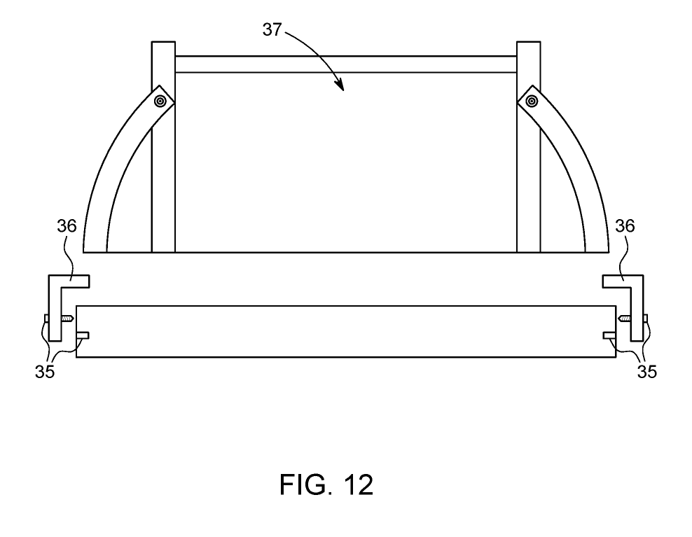

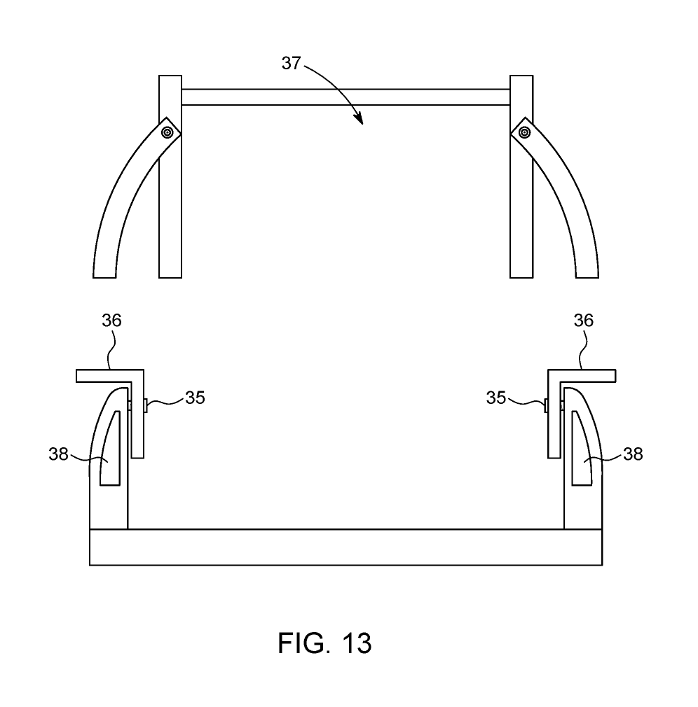

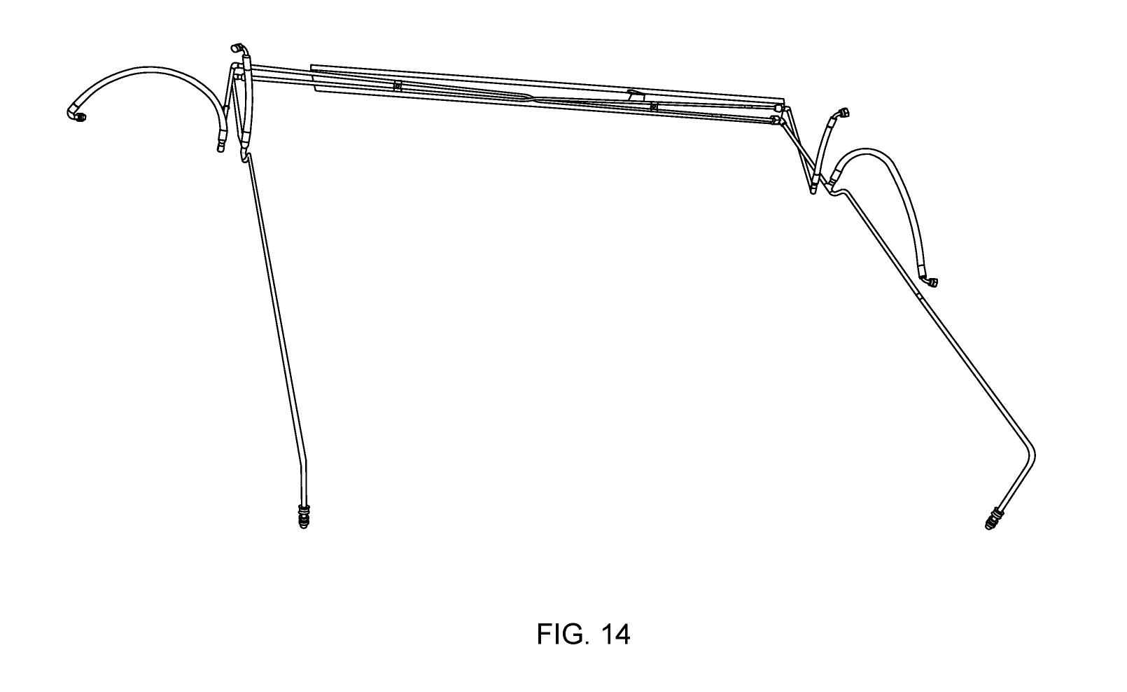

Reference is made to FIGS. 12 and 13. FIG. 12 is a rear view of the invention as if installed on a flat bed truck. FIG. 13 is a rear view of the invention as if installed on a standard pick up truck. The swing arm angle is reversed from FIG. 13, which allows for a clean company operation, taking up as little room as possible.

In these diagrams, item (35) is a pivot bolt in the pivot bolt hole, (36) is a swing arm, (37) is the rack, and (38) are the tail lights.

### The Four Hydraulic Cylinders

The lifting device incorporates Four Hydraulic Cylinders that are attached to two hoses in a manner according to FIGS. 1A, 1B, 1C, and 1D. Likewise, the Four Hydraulic Cylinders are under the control of a hydraulic system which is capable of controlling all four hydraulic cylinders simultaneously to operate the lifting device.

Reference is made to FIG. 14, which is a view of the metal hydraulic lines that support the invention.

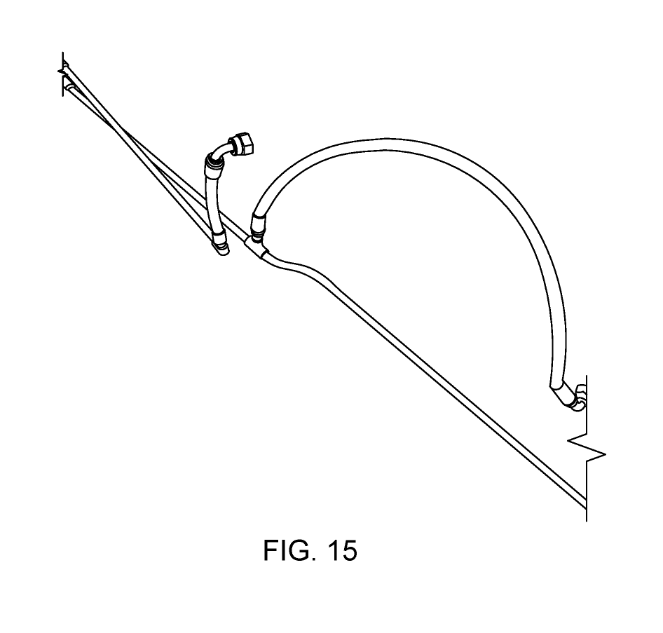

Reference is also made to FIG. 15, which is a close-up view of the metal hydraulic lines that support the invention.

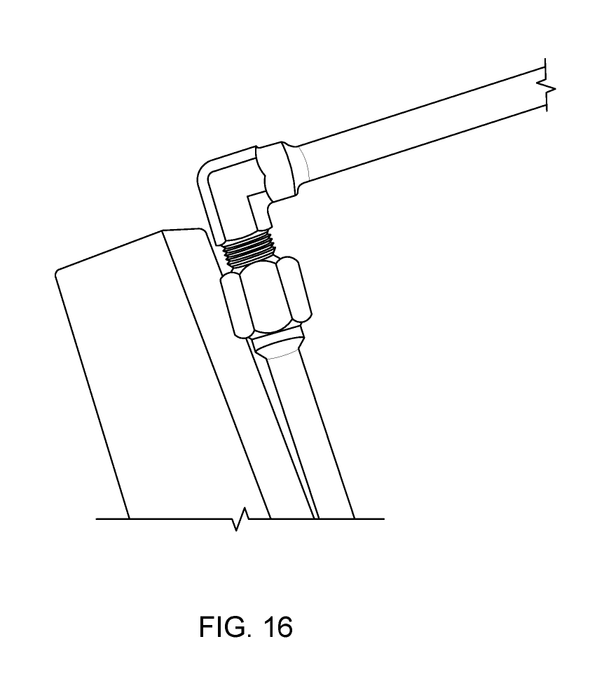

Reference is also made to FIG. 16, which is a close-up view of the L-joints within the metal hydraulic lines that support the invention.

In a preferred embodiment, hydraulic cylinder mounting brackets are located on the Swing Arm Assembly behind the (19) left pivot plate and the (20) right pivot plate

Each hydraulic pump can be any hydraulic pump that is available to one of skill in the art. But in a preferred embodiment, the hydraulic pump is a four-way 12 volt DC hydraulic pump, which is sold commercially by MTE Hydraulic®. In this example, the lifting device has a working load of 5,000 lbs.

In an exemplary embodiment, each hydraulic pump may include one or more valves which are operative to provide hydraulic fluid pressure sufficient to operate at least one hydraulic cylinder. Such a hydraulic cylinder may include a piston that moves within a cylinder barrel responsive to hydraulic fluid pressure provided by the hydraulic pump. In response to movement of the piston, a rod connected to the piston moves longitudinally to provide a pushing or pulling force that urges the lifting device to deploy or retract.

In a preferred embodiment, each hydraulic cylinder is approximately 18″ in length with extendible cylinders approximately 12″ in length. The hydraulic pump will have a maximum output of 3500 psi, but in a preferred embodiment, a pressure of 2,500 psi should be sufficient to lift a load of 2,000 pounds onto the truck.

In a preferred embodiment, a hydraulic cylinder mounting bracket is installed on both the (21) Left Stationary Arm and (22) Right Stationary Arm. Each hydraulic cylinder mounting bracket is 6 inches long and is made of ⅜ inch angle. At this point, the hydraulic cylinder is secured with 1″ pin that is reinforced with a 1″ washer, which is welded in place. For added strength, there are several gussets welded within the mounting bracket.

It is envisioned that the invention is compatible with many flatbed and pickup trucks that are commercially available. Further, many models of trucks are available with 6.5′ beds or with 8′ beds. The present examples are compatible with trucks with 6.5′ beds, such as the Dodge Ram. For beds with 8′ beds, one of skill in the art would use ordinary skill to adjust the length of the swings arms and the stationary arms.

As will be appreciated, the foregoing objects and examples are exemplary and embodiments need not meet all or any of the foregoing objects, and need not include all or any of the exemplary features described herein. Additional aspects and embodiments within the scope of the claims will be devised by those having skill in the art based on the teachings set forth herein.

While the invention has been described in connection with what are considered to be exemplary embodiments, it is to be understood that the invention is not limited to the disclosed embodiments, but on the contrary, is intended to cover various modifications and equivalent arrangements included within the spirit and scope of the appended claims.

I claim:

1. A lifting apparatus mounted on a pick-up truck comprising:
(a) a rack assembly
(b) a swing arm assembly
(c) at least one hydraulic arm

2. A method of hoisting an object onto the bed of a pick-up truck, using a lifting device comprising:
(a) a rack assembly
(b) a swing arm assembly
(c) at least one hydraulic arm
